(19) United States
(12) Patent Application Publication
(10) Pub. No.: US 2025/0328370 A1
(43) Pub. Date: Oct. 23, 2025

(54) REPLACEMENT OF A HOST IN A MULTI-HOST ENVIRONMENT

(71) Applicant: Dell Products L.P., Round Rock, TX (US)

(72) Inventors: Qin Wang, Northborough, MA (US); Julie Zhivich, Westborough, MA (US); Jitender Sawal, Newton, MA (US); Jonathan Krasner, Coventry, RI (US)

(73) Assignee: Dell Products L.P., Round Rock, TX (US)

(21) Appl. No.: 18/642,912

(22) Filed: Apr. 23, 2024

(51) Int. Cl. G06F 9/455; G06F 9/54

(52) U.S. Cl. CPC G06F 9/45558; G06F 9/542; G06F 2009/45591; G06F 2009/45595

(57) ABSTRACT

One or more aspects of the present disclosure relate to replacing a network interface controller (NIC)/host in a multi-host environment. In embodiments, a status of a first host in a first server is monitored by a second host in a second server using an out-of-band control messaging interface. In addition, communications destined to the first host or directed through a first NIC corresponding to the first host and in the first server is controlled based on the status of the first host. Further, resources on the first NIC and established for the second host is managed based on the status of the first host.

### BACKGROUND

A multi-host environment refers to a network or computing setup where multiple host systems, also known as root complexes in specific contexts like Peripheral Component Interconnect Express (PCIe) architectures, share, and access common resources. These resources can include Network Interface Controllers (NICs), storage devices, memory, and other peripherals or services. A “host” can include a computer or server equipped with a processor and operating system capable of running applications and managing hardware resources.

### SUMMARY

One or more aspects of the present disclosure relate to replacing a network interface controller (NIC)/host in a multi-host environment. In embodiments, a status of a first host in a first server is monitored by a second host in a second server using an out-of-band control messaging interface. In addition, communications destined to the first host or directed through a first NIC corresponding to the first host and in the first server is controlled based on the status of the first host. Further, resources on the first NIC and established for the second host is managed based on the status of the first host.

In embodiments, a second host in a second server can determine that the first host in the first server is being replaced.

In embodiments, the second host can receive a notification regarding a replacement of the first host via the out-of-band control messaging interface.

In embodiments, communications through the first network interface controller can be redirected to a second network interface controller corresponding to the second host and in the second server in response to a replacement status of the first host. In addition, the second host can include a primary communication link with the second network interface controller.

In embodiments, the second host can receive a notification regarding the replaced status of the first host via the out-of-band control messaging interface.

In embodiments, resources established for the second host prior to the replaced status of the first host from the first network interface controller can be released in response to receiving the notification.

In embodiments, memory and chip resources corresponding to stale communications of the second host over the first network interface can be released.

In embodiments, a secondary communications link between the second host and the first network interface controller can be established in response to receiving the notification regarding the replaced status of the first host.

In embodiments, first and second host virtual ports can be established on both the first and second network interface controllers.

In embodiments, system hardware resources can be built on the first network interface controller for use by the second host.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a block diagram of a server system in accordance with embodiments of the present disclosure.

FIG. 3 is a block diagram of a path management subsystem in accordance with embodiments of the present disclosure.

FIG. 4 is a flow diagram of a method for replacing a network interface controller (NIC)/host in a multi-host environment per embodiments of the present disclosure.

FIG. 5 is a flow diagram of a method for managing communications and resources in response to replacing a network interface controller (NIC)/host in a multi-host environment per embodiments of the present disclosure.

### DETAILED DESCRIPTION

A business like a financial or technology corporation can produce large amounts of data and require sharing access to that data among several employees. Such a business often uses storage arrays to store and manage the data. Because a storage array can include multiple storage devices (e.g., hard-disk drives (HDDs) or solid-state drives (SSDs)), the business can scale (e.g., increase or decrease) and manage an array's storage capacity more efficiently than a server. In addition, the business can use a storage array to read/write data required by one or more business applications.

Occasionally, a business can provide employees and customers with access to different services and applications via a multi-server (e.g., multi-host) environment. A multi-server environment is a server infrastructure that uses multiple servers to provide users access to various services and applications. Advantageously, a multi-server environment can offer a higher level of reliability and availability than a single-server environment. For example, if one server in a multi-server environment goes down, the other servers can continue to provide access to certain services and applications users need. In addition, a multi-server environment can offer a higher level of performance than a single-server environment because the load can be distributed across multiple servers.

Traditionally, in computing environments, each host (or server) is paired with its own Network Interface Controller (NIC), which serves as the interface between the host and the rest of the network. This setup is straightforward and works well for many applications, but it has scalability, flexibility, and resource utilization limitations. In particular, it does not allow for the dynamic sharing of NICs among multiple hosts, leading to underutilization of network resources and increased costs in large-scale deployments.

In response to these limitations, multi-host environments have been developed. In such environments, multiple hosts share access to a pool of NICs. This approach can significantly improve resource utilization and flexibility, as NICs can be dynamically allocated to hosts based on current demand. The approach is instrumental in data centers and cloud computing platforms, where workloads can vary dramatically.

Embodiments of the present disclosure include managing network interface controllers (NICs) in a multi-host environment, explicitly addressing the challenges of replacing a host or NIC within such a system. For example, the embodiments include an intelligent, proprietary out-of-band control messaging interface and comprehensive resource management system. The system is designed to handle the challenges of replacing a host or NIC in a multi-host environment, such as avoiding unexpected PCI resets or stalls and efficiently reconfiguring the network to work with the new host/NIC. Advantageously, the embodiments improve the reliability and serviceability of multi-host environments as described in greater detail herein.

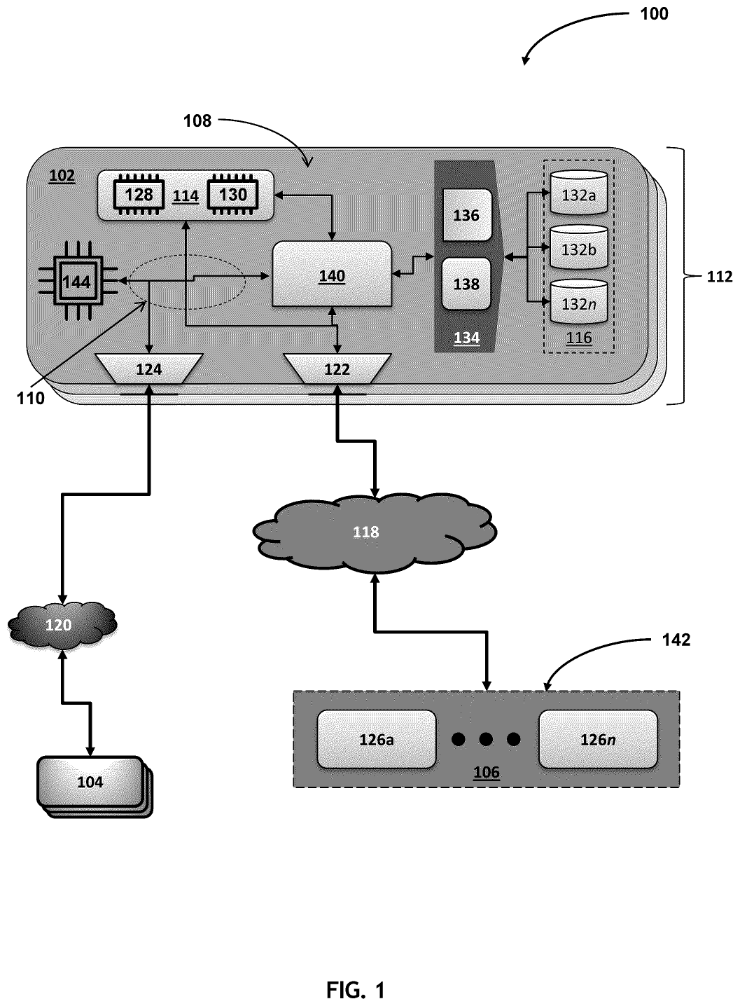

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, busses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and the like. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (iSCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the hosts 106 can have a multi-server (e.g., multi-host) architecture. Specifically, each client machine 126a-n can be a physical server (e.g., a server blade in a server rack). For example, the multi-host architecture (or environment) can define a network or computing setup where multiple host systems, also known as root complexes in certain contexts like PCI Express (PCIe) architectures, share, and access common resources. These resources can include Network Interface Controllers (NICs), storage devices, memory, and other peripherals or services. A “host” can include a computer or server equipped with a processor and operating system capable of running applications and managing hardware resources.

In embodiments, a multi-host environment 142 includes multiple hosts (e.g., root complexes) sharing multiple NICs. Each NIC is designated a primary host and a secondary host, and similarly, each host is assigned a primary NIC and a secondary NIC. This setup enhances resource utilization, increases redundancy, and improves system performance and flexibility. However, it also introduces complexity in managing the shared resources, especially in handling the dynamic nature of the environment, such as when a host or NIC fails or needs to be replaced.

As described in greater detail herein, embodiments of the present disclosure address the complexities of replacing a host or Network Interface Controller (NIC) in a multi-host environment 142, where multiple NICs are shared among various root complexes (hosts). Advantageously, the embodiments can ensure seamless operation and minimal disruption during the replacement process of a host/NIC. For example, the embodiments can leverage intelligent proprietary out-of-band control messaging interfaces for coordination, comprehensive resource management to adapt to system state changes, and a path management subsystem coupled with a system failover scheme to efficiently handle traffic and resource allocation.

Embodiments of the present disclosure use out-of-band control messaging for real-time communication between hosts and NICs, ensuring that all components are synchronized throughout the replacement process. For example, the embodiments can use the out-of-band control messaging for initial detection and communication of the replacement need, management of system resources to accommodate the new host/NIC, and reconfiguring system paths and virtual ports (Vports) to restore full operational capabilities. The embodiments also introduce a novel approach to managing PCIe initialization and driver installation, further facilitating the seamless integration of replaced hosts/NICs into the existing multi-host environment. The embodiments aim to double system bandwidth through these mechanisms while enhancing fault handling, isolation, and overall system serviceability in complex multi-host configurations.

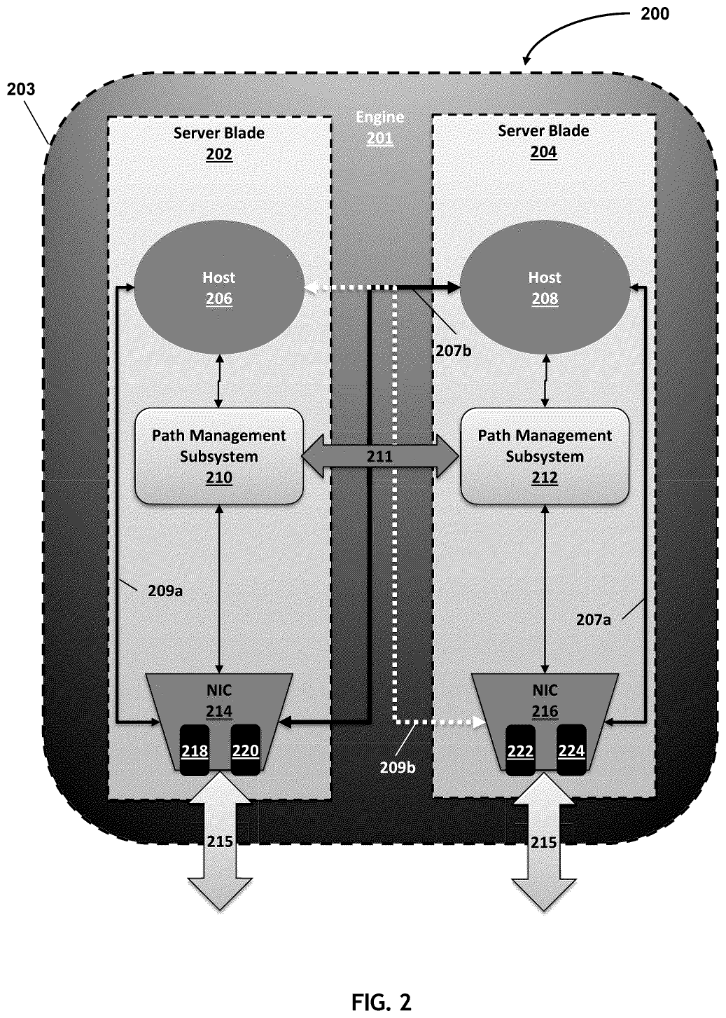

Regarding FIG. 2, a server system 200 can include an engine 201 housed in a shelf (e.g., housing) 203 that interfaces with a cabinet or server rack (not shown). The engine 201 can include hardware and circuitry configured to provide host services via, e.g., one or more server blades (e.g., boards). For example, the engine 201 can include a pair of server blades 202/204 with hardware, circuitry, and logic configured to host applications and services used by employees or customers of a business or organization. The server system 200 can also include a multi-host environment architecture where multiple hosts 206/208, also known as root complexes in contexts like PCI Express (PCIe) architectures, share and access common resources. The resources can include Network Interface Controllers (NICs), storage devices, memory, and other peripherals or services.

In embodiments, a first server blade 202 can include a first host 206, and a second server blade 204 can include a second host 208. In addition, each server blade 202/204 can include a network interface controller (NIC) 214/216 configured to enable communications with devices on a network (e.g., the SAN 118 of FIG. 1). For example, the first and second hosts 206/208 can include respective processors and operating systems that run applications and services for employees/customers of a business or organization. Accordingly, each NIC 214/216 includes hardware/circuitry configured to enable the hosts 206/208 to communicate with a physical layer and a data link layer standard such as Ethernet for Wi-Fi corresponding to the network.

In embodiments, the multi-host environment architecture of the server system 200 involves multiple hosts (e.g., the hosts 206/208) sharing multiple NICs (e.g., the NICs 214/216). Specifically, each NIC is designated a primary host and a secondary host, and similarly, each host is assigned a primary NIC and a secondary NIC. For example, the first host 206 can use a first NIC 214 as its primary NIC and a second NIC 216 as its secondary NIC. Further, the first host 206 can be communicatively coupled to the first NIC 214 via a primary PCIe link 209a. The first host 206 can also be communicatively coupled to the second NIC 216 via a secondary PCIe link 209b. The second host 208 can also use the first NIC 214 as its secondary NIC and the second NIC as its primary NIC. Accordingly, the second host 208 can be communicatively coupled to the first NIC 214 via a secondary PCIe link 207b and communicatively coupled to the second NIC 216 via a primary PCIe link 207a.

In embodiments, the server system 200 can establish in-band communications channels 215 with devices (e.g., the storage array 102 of FIG. 1) on a network (e.g., the SAN 118 of FIG. 1). Accordingly, the in-band communication channels 215 can correspond to primary data channels used by the hosts 206/208 for controlling or managing data over the network. For example, the hosts 206/208 can run applications that read/write data on a storage array connected to the network.

In embodiments, the hosts 206/208 can include respective path management subsystems 210/212 that include hardware, circuitry, and logic configured to dynamically manage paths through which data travels between the hosts 206/208 and the NICs 214/216. For example, the path management subsystems 210/212 can configure and synchronize virtual ports (Vports) 218/220/222/224 corresponding to physical NICs 214/206 ports. Specifically, the path management subsystems can establish the Vports 218/220/222/224 as logical constructs that allow for the separation and management of traffic within a physical network interface (e.g., physical ports (not shown) of the NICs 214/216). Accordingly, the Vports can allow the path management subsystems 210/212 and the hosts 206/208 to allocate and isolate network resources efficiently. For instance, the first NIC 214 can include a first Vport 218 that manages traffic corresponding to the first host 206 and a second Vport 220 that manages traffic corresponding to the second host 208. Likewise, the second NIC 216 can include a first Vport 222 that manages traffic corresponding to the second host 208 and a second Vport 224 that manages traffic corresponding to the first host 206.

The path management subsystems 210/212 in embodiments can be communicatively linked via an out-of-band interface 211. The out-of-band interface 211 enables coordination between the hosts 206/208 and the NICs 214/216. For example, the out-of-band interface 211 provides a dedicated management and control channel separate from a primary data communication path (e.g., in-band communication channels 215). The separate management and control channel ensures that control messages can be sent even if the primary data path is compromised or undergoing maintenance (such as during a host/NIC replacement).

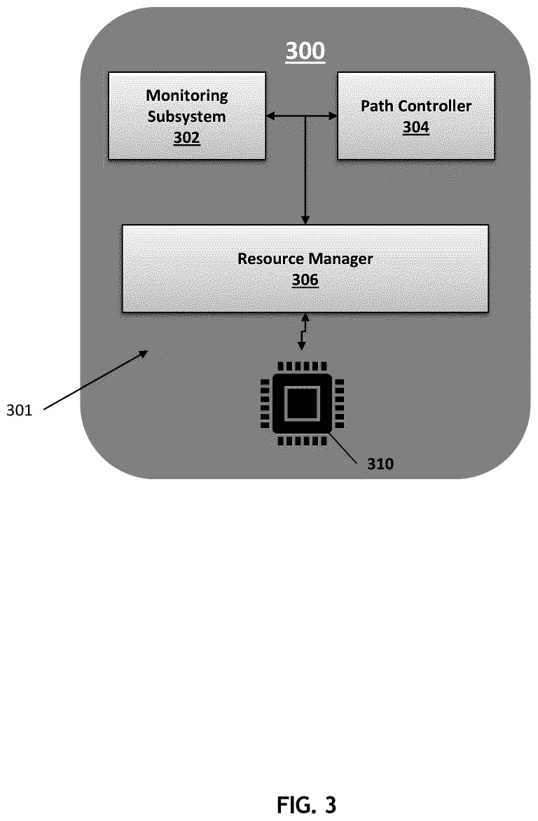

Regarding FIG. 3, a path management subsystem 300 can be substantially similar to the path management subsystems 210/212 of FIG. 2. Accordingly, the path management subsystem 300 can include hardware, circuitry, or logical components 301 configured to manage communications paths corresponding to hosts (e.g., the hosts 206/208 of FIG. 2).

In embodiments, the path management subsystem 300 can include a monitoring subsystem 302 that continuously monitors the health and status of paths corresponding to hosts (e.g., the hosts 206/208 of FIG. 2). For instance, the monitoring subsystem 302 can monitor traffic corresponding to the hosts and corresponding primary/secondary NICs (e.g., the NICs 214/216) over in-band communication channels (e.g., channels 215 of FIG. 2) over a network (e.g., the SAN 118 of FIG. 1). In addition, the monitoring subsystem 302 can determine and measure metrics corresponding to the bandwidth, latency, and critical nature of data being transmitted over network data paths. Further, the monitoring subsystem302 can maintain a data structure corresponding to the metrics in a local memory 310.

Additionally, the monitoring subsystem 302 can receive command signals via an out-of-band interface (e.g., the interface 211 of FIG. 2) corresponding to a host/NIC replacement. For example, referring back to FIG. 2, the first host 206 can detect a critical failure, and thus, it or its corresponding primary NIC (e.g., the NIC 214 of FIG. 2) needs to be replaced. Accordingly, the first host 206 or its corresponding path management subsystem 210 can send an alert to the second host 208, indicating that it is going offline for replacement. In response to receiving the alert, the monitoring subsystem 302 can acknowledge the alert, and the path management system 300 or one of its other components 301 can initiate failover procedures (e.g., traffic rerouting).

In embodiments, the path management subsystem 300 can include a path controller 304 configured to control and manage traffic corresponding to a host. For example, the path controller 304 can retrieve bandwidth and latency metrics corresponding to one or more paths corresponding to in-band communication channels (e.g., the channels 215 of FIG. 2) over, e.g., the SAN 118 of FIG. 1. The path controller 304 can use the metrics to prioritize specific paths over others to ensure that the most important data continues to flow smoothly. Further, the path controller 304 can reroute traffic away from a host/NIC in response to the monitoring subsystem 302 receiving an alert regarding replacing the host/NIC. For example, the path controller 304 can establish or identify alternative paths that can handle traffic over the network temporarily.

In embodiments, the monitoring subsystem 302, e.g., corresponding to the path management subsystem 212 of FIG. 2, can receive a notification from the first host 206 that it or its corresponding first NIC 215 has been replaced and is ready for use. Accordingly, the path controller 304 can establish a secondary PCIe link (e.g., PCIe link 207b) between the second host 208 and the first NIC 214 of FIG. 2.

In embodiments, the path management subsystem 300 can include a resource manager 306 that manages memory and hardware resources corresponding to a host/NIC. For example, in response to receiving the replaced status corresponding to the first host 206 or its corresponding first NIC 215, the resource manager 306 can release memory and hardware resources of the second host 208 associated with the first NIC 214. Further, the resource manager 306 can notify its counterpart in the path management subsystem (e.g., the subsystem 210 of FIG. 1) corresponding to the first host 206 of an initialization status of the second host 208. In response to the notification, the counterpart resource manager 306 can establish Vports 218/220 on the first NIC 214.

Additionally, the counterpart resource manager 206 can instruct the resource manager 306 of path management subsystem 212 corresponding to the second host 208 to establish Vports on the second NIC 216. Thus, the resource manager 306 of the path management subsystem 212 can establish Vports 222/224 on the second NIC 216. Further, the resource manager 206 can establish and build new system memory, hardware, and chip resources corresponding to the first NIC 214 for use by the second host 208. Likewise, the counterpart resource manager 206 can establish and build new system memory, hardware, and chip resources corresponding to the second NIC 214 for use by the first host 208 in response to receiving a system status of the second host 208.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

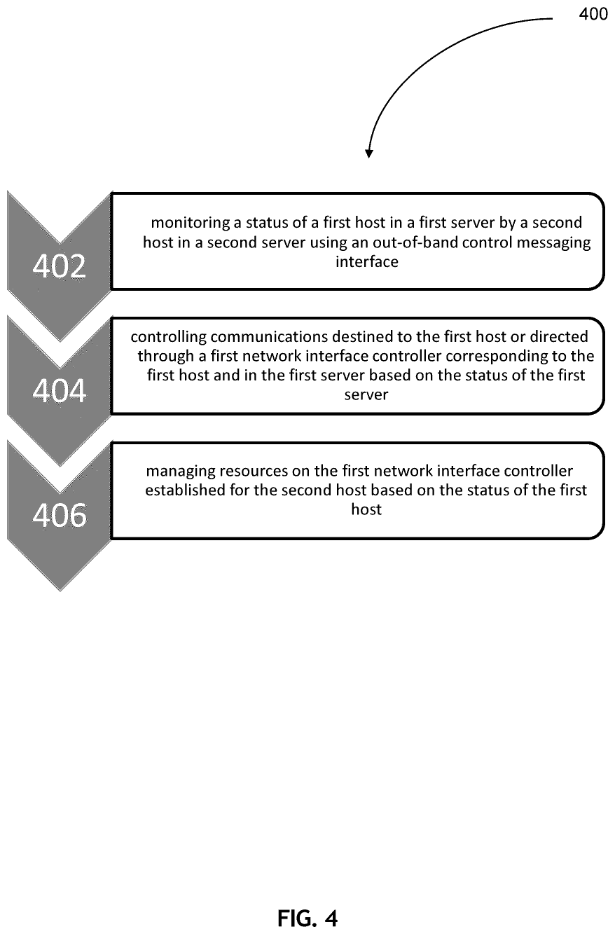

Regarding FIG. 4, a method 400 relates to replacing a network interface controller (NIC)/host in a multi-host environment. In embodiments, a path management subsystem (e.g., subsystem 300 of FIG. 3) can perform all or a subset of operations corresponding to the method 400.

For example, the method 400, at 402, can include monitoring a status of a first host in a first server by a second host in a second server using an out-of-band control messaging interface. Additionally, at 404, the method 400 can include controlling communications destined to the first host or directed through a first network interface controller corresponding to the first host and in the first server based on the status of the first host. Further, the method 400, at 406, can include managing resources on the first network interface controller established for the second host based on the status of the first host.

Further, each operation can include any combination of techniques implemented by the embodiments described herein. Additionally, one or more of the components 301 of the path management subsystem 300 can implement one or more of the operations of each method described above.

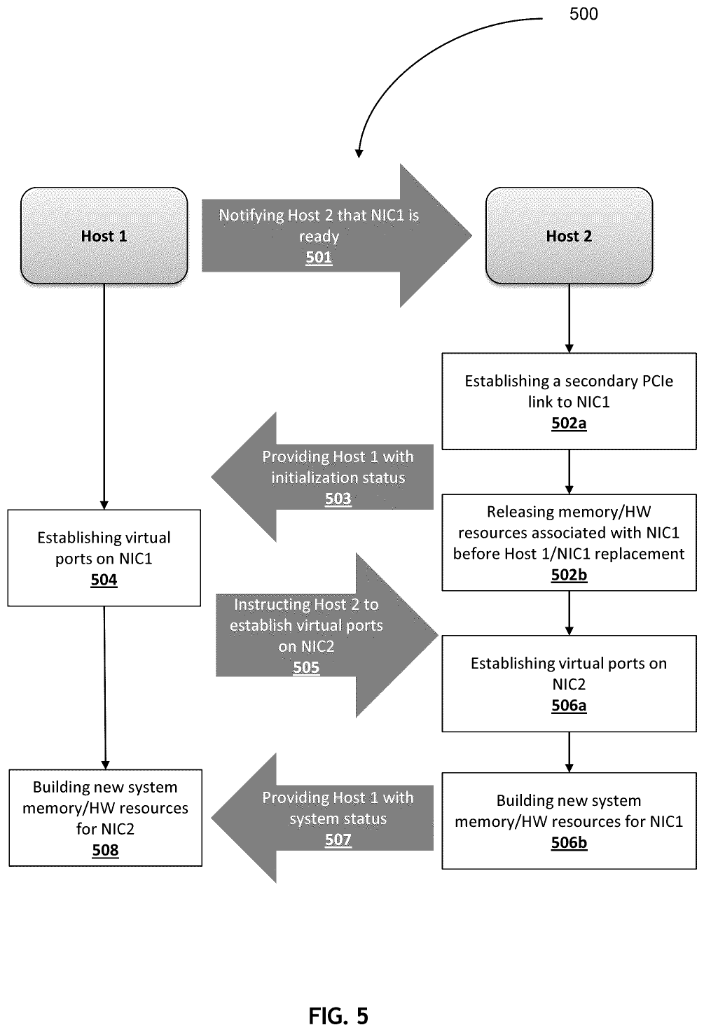

Regarding FIG. 5, a method 500 relates to replacing a network interface controller (NIC)/host in a multi-host environment (e.g., the environment 200 of FIG. 2). In embodiments, a path management subsystem (e.g., the subsystem 300 of FIG. 3) can perform all or a subset of operations corresponding to the method 500 via an out-of-band control messaging interface/channel (e.g., messaging interface/channel 211 of FIG. 2).

The method 500, at 501, can include notifying a peer/secondary host (e.g., Host 2) by a primary host (e.g., Host 1) that the primary host's corresponding NIC (e.g., NIC 1 or NIC 214 of FIG. 2) is ready (e.g., has been replaced). For example, the path management subsystem (e.g., subsystem 210 of FIG. 2) corresponding to the primary host (or Host 1) can issue the notification via the out-of-band control messaging interface/channel.

At 502a, the method 500 can include establishing a secondary PCIe link to the primary host's corresponding NIC. For example, the peer host (or Host 2) or a path management subsystem (e.g., subsystem 212of FIG. 2) of the peer host can establish a PCIe link to the primary host's corresponding NIC secondary to a primary PCIe link between the peer host and its corresponding peer NIC (e.g., NIC 2 or NIC 216 of FIG. 2). Further, the method 500, at 502a, can include installing and configuring drivers corresponding to the primary host's NIC. Specifically, the peer host's path management subsystem can obtain and configure the drivers required to use the primary host's NIC.

In addition, at 502b, the method 500 can include releasing memory/hardware (HW) resources associated with the primary host's previously corresponding NIC (e.g., before the replacement). For example, the peer host's corresponding path management subsystem can clean up host memory and chip resources associated with stale message transport over the primary host's previously corresponding NIC. Further, the method 500, at 503, can include providing the primary host with an initialization status corresponding to the peer host via, e.g., the out-of-band control messaging interface/channel.

The method 500, at 504, can further include establishing virtual ports on the primary host's corresponding NIC. For instance, the primary host's corresponding path management subsystem can establish a first virtual port (VPort₀) and a second virtual port (VPort₁) on the primary host's corresponding NIC. Specifically, the primary host's path management subsystem can establish and assign the first virtual port to manage communications corresponding to the primary host over a network (e.g., the SAN 118 of FIG. 1). Likewise, the primary host's path management system can establish and assign the second virtual port to manage communications corresponding to the peer host over the network.

Further, at 505, the method 500 can include instructing the peer host to establish virtual ports on the peer host's corresponding NIC. Specifically, the primary host's path management subsystem can issue virtual port setup instructions to the peer host via the out-of-band control messaging interface/channel.

At 506a, the method 500 can include establishing virtual ports on the peer host's corresponding NIC. For example, the peer host's corresponding path management subsystem can establish a first virtual port (VPort₀) and a second virtual port (VPort₁) on the peer host's corresponding NIC. Specifically, the peer host's path management subsystem can establish and assign the first virtual port to manage communications corresponding to the peer host over a network (e.g., the SAN 118 of FIG. 1). Likewise, the peer host's path management system can establish and assign the second virtual port to manage communications corresponding to the primary host over the network.

Additionally, at 506b, the method 500 can include building system memory and hardware resources for the peer host to use the primary host's NIC. For example, the peer host's path management subsystem can configure chip resources required to use the primary host's corresponding NIC. Subsequently, the method 500, at 507, can include providing the primary host with an update of the system status corresponding to the peer host. Further, the method 500, at 508, can include building system memory and hardware resources for the primary host to use the peer host's NIC. For example, the primary host's path management subsystem can configure chip resources required to use the peer host's corresponding NIC.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

1. A method comprising:
monitoring a status of a first host in a first server by a second host in a second server using an out-of-band control messaging interface in a multi-host environment where the first host and second host share access to a first network interface controller and a second network interface controller;
controlling communications destined to the first host or directed through a first network interface controller corresponding to the first host and in the first server based on the status of the first host, wherein the first network interface controller includes virtual ports for managing traffic corresponding to both the first host and the second host; and
managing resources on the first network interface controller established for the second host based on the status of the first host, wherein managing resources includes dynamically allocating and deallocating memory and hardware resources on the shared first network interface controller based on host replacement status.

2. The method of claim 1, further comprising:
determining, by a second host in a second server, the first host in the first server is being replaced.

3. The method of claim 2, further comprising:
receiving a notification regarding a replacement of the first host via the out-of-band control messaging interface by the second host.

4. The method of claim 1, further comprising:
redirecting communications through the first network interface controller to a second network interface controller corresponding to the second host and in the second server in response to a replacement status of the first host, wherein the second host includes a primary communication link with the second network interface controller.

5. The method of claim 4, further comprising:
receiving a notification regarding a replaced status of the first host via the out-of-band control messaging interface by the second host.

6. The method of claim 5, further comprising:
releasing resources established for the second host prior to the replaced status of the first host from the first network interface controller in response to receiving the notification.

7. The method of claim 6, wherein releasing the resources includes releasing memory and chip resources corresponding to stale communications of the second host over the first network interface.

8. The method of claim 7, further comprising:
establishing a secondary communications link between the second host and the first network interface controller in response to receiving the notification regarding the replaced status of the first host.

9. The method of claim 8, further comprising:
establishing first and second host virtual ports on both the first and second network interface controllers.

10. The method of claim 9, further comprising:
building system hardware resources on the first network interface controller for use by the second host.

11. An apparatus with a memory and processor, the apparatus configured to:
monitor a status of a first host in a first server by a second host in a second server using an out-of-band control messaging interface in a multi-host environment where the first host and second host share access to a first network interface controller and a second network interface controller;
control communications destined to the first host or directed through a first network interface controller corresponding to the first host and in the first server based on the status of the first host, wherein the first network interface controller includes virtual ports for managing traffic corresponding to both the first host and the second host; and
manage resources on the first network interface controller established for the second host based on the status of the first host, wherein managing resources includes dynamically allocating and deallocating memory and hardware resources on the shared first network interface controller based on host replacement status.

12. The apparatus of claim 11, further configured to:
determine, by a second host in a second server, the first host in the first server is being replaced.

13. The apparatus of claim 12, further configured to:
receive a notification regarding a replacement of the first host via the out-of-band control messaging interface by the second host.

14. The apparatus of claim 11, further configured to:
redirect communications through the first network interface controller to a second network interface controller corresponding to the second host and in the second server in response to a replacement status of the first host, wherein the second host includes a primary communication link with the second network interface controller.

15. The apparatus of claim 14, further configured to:
receive a notification regarding a replaced status of the first host via the out-of-band control messaging interface by the second host.

16. The apparatus of claim 15, further configured to:
release resources established for the second host prior to the replaced status of the first host from the first network interface controller in response to receiving the notification.

17. The apparatus of claim 16, further configured to:
release memory and chip resources corresponding to stale communications of the second host over the first network interface.

18. The apparatus of claim 17, further configured to:
establish a secondary communications link between the second host and the first network interface controller in response to receiving the notification regarding the replaced status of the first host.

19. The apparatus of claim 18, further configured to:
establish first and second host virtual ports on both the first and second network interface controllers.

20. The apparatus of claim 19, further configured to:
build system hardware resources on the first network interface controller for use by the second host.
